(19) United States
(12) Patent Application Publication
(10) Pub. No.: US 2013/0321470 A1
(43) Pub. Date: Dec. 5, 2013

(54) APPARATUS AND METHOD FOR VIEWING AN IMAGE THAT IS LARGER THAN AN AREA OF A DISPLAY DEVICE

(71) Applicant: Samsung Electronics Co., Ltd., Gyeonggi-do (KR)

(72) Inventors: Young-Min LEE, Moscow (RU); Ilya Vladimirovich SAFONOV, Moscow (RU); Ilya Vasilyevich KURILIN, Novosibirsk (RU)

(21) Appl. No.: 13/910,799

(22) Filed: Jun. 5, 2013

(30) Foreign Application Priority Data
Jun. 5, 2012 (RU) 2012122959

(51) Int. Cl. G09G 5/373; G06F 3/041

(52) U.S. Cl. CPC G09G 5/373; G06F 3/041
USPC 345/660; 345/173

(57) ABSTRACT

An apparatus and method are provided for viewing an image on a display device, where the image is larger than a display area of the display device. The method includes selecting an area of the image; detecting background and foreground areas in non-selected areas of the image; and displaying the image on the display device. The selected area of the image is displayed in a predetermined scale, all of the background and foreground areas in the non-selected areas of the image are simultaneously displayed on the display device, a degree of deformation of the background areas, differs from a degree of deformation of the foreground areas, and the degree of deformation of the foreground areas changes in relation to distance moving away from the selected area.

### PRIORITY

This application claims priority under 35 U.S.C. §119(a) to Russian Patent Application No. 2012122959, which was filed in the Russian Patent Office on Jun. 5, 2012, the entire content of which is hereby incorporated by reference.

### BACKGROUND OF THE INVENTION

1. Field of the Invention The present invention relates generally to the processing of digital signals, and more particularly to systems and methods for viewing and navigation of a digital image having dimensions that exceed display screen dimensions.

2. Description of the Related Art

Currently, mobile devices, such as smart phones, tablet Personal Computers (PCs), electronic books, etc., are widespread all over the world. These devices possess sufficient computational capabilities for operation with digital images, e.g., images of documents and books. However, frequently pixel dimensions of these images considerably exceed the relatively small screens of the mobile devices, and as such, viewing of the images on the mobile devices may be inconvenient for users.

For documents with “hard” formatting, e.g., PDFs, and for large images, e.g., geographical maps, the size of these images, especially in an enlarged view, often exceeds a screen size by a considerable amount. As a result, current mobile devices fail to provide comfortable conditions of viewing and navigating the large image.

Various methods of image display on the screen and image viewing are available in related art.

FIG. 3 illustrates a conventional method for displaying an image on a mobile device.

Referring to FIG. 3, for example, in the mobile application Polaris Office 3.0, a portion of an initial image, i.e., the image illustrated in FIG. 1A, is displayed. As illustrated in FIG. 3, the scale of viewing the image used in Polaris Office remains constant for the displayed portion of the image.

More specifically, the mobile device displays a portion 301 of the image or document page. A minimized view of the initial image 303, e.g., a thumbnail, and a display box 302 identify which portion of the initial image is current being displayed. For example, the minimized view of the initial image 303 appears for a few seconds when moving a viewpoint by the user.

However, when using the conventional procedure illustrated in FIG. 3, navigating over the image can be tiresome, as the user may have to move the viewpoint of the image many times.

In another conventional method, for example, as described in U.S. Patent Application 2009/0189920 a page of a document including text and graphics is segmented into different areas. Each of the areas has changed scale, which depends on the area type. Therefore, during interactive navigating across a document image, the scale of the displayed image is automatically customized for each of the segmented areas thereof.

Additionally, Japanese Patent Application 2009080573 describes a method for displaying an image on a screen in which a viewpoint (i.e., an area of interest) is displayed on a display device in an increased scale. Other areas are displayed with a fixed reduced scale.

FIG. 4 illustrates a conventional method for displaying an image on a mobile device. Specifically, FIG. 4 illustrates a method as described in Japanese Patent Application 2009080573, described above.

Referring to FIG. 4, the initial image as illustrated in FIG. 1A is displayed such that a selected area 404 is displayed with an increase scale, as compared to a non-selected area 403, which is displayed with a reduced scale.

Additionally, Japanese Patent Application 2011112678 is directed to a method of displaying an image, wherein a selected area of the image is represented in an increased scale, and the scale of other areas is step-by-step decreased in a direction to the edges of the display device.

FIG. 5 illustrates a conventional method for displaying an image on a mobile device. Specifically, FIG. 5 illustrates a method as described in Japanese Patent 2011112678, described above.

Referring to FIG. 5, the initial image as illustrated in FIG. 1A is displayed such that a selected area 502 is displayed with an increase scale, and a non-selected area 501 is displayed with a step-by-step reduced scale, which increases towards the edges of the display area.

However, while the above-described conventional methods provide some advantages, they are still inconvenient for a user that has to select several areas on the image when working with documents on which several columns of the text and tables are presented. Additionally, in the conventional methods, the scale of the non-selected areas of the image always decreases, without giving the user other options.

### SUMMARY OF THE INVENTION

Accordingly, the present invention is designed to address at least the problems and/or disadvantages described above and to provide at least the advantages described below.

Accordingly, an aspect of the present invention is to provide an improved apparatus and method for viewing an image having a size that exceeds a display device size.

In accordance with an aspect of the present invention, a method is provided for viewing an image on a display device, where the image is larger than a display area of the display device. The method includes selecting an area of the image; detecting background and foreground areas in non-selected areas of the image; and displaying the image on the display device. The selected area of the image is displayed in a predetermined scale, all of the background and foreground areas in the non-selected areas of the image are simultaneously displayed on the display device, a degree of deformation of the background areas, differs from a degree of deformation of the foreground areas, and the degree of deformation of the foreground areas changes in relation to distance moving away from the selected area.

In accordance with another aspect of the present invention, an apparatus is provided for viewing an image on a display device, where the image is larger than a display area of the display device. The apparatus includes a touchscreen display including the display area of the display device configured to display the image, and to receive a user input for selecting an area of the image; and a controller configured to detect background and foreground areas in non-selected areas of the image, to control the touchscreen display to display the image on the display device. The selected area of the image is displayed in a predetermined scale, all of the background and foreground areas in the non-selected areas of the image are simultaneously displayed on the display device, a degree of deformation of the background areas, differs from a degree of deformation of the foreground areas, and the degree of deformation of the foreground areas changes in relation to distance moving away from the selected area.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1A illustrates an example of an initial image that is larger than a display area of a mobile device;

FIG. 1B illustrates a illustrates the initial image as displayed on a mobile device according to an embodiment of the present invention;

FIG. 2 illustrates the differences of scale between the initial image as illustrated in FIG. 1A and the displayed image illustrated in FIG. 1B according to an embodiment of the present invention;

FIG. 3 illustrates a conventional method for displaying an image on a mobile device;

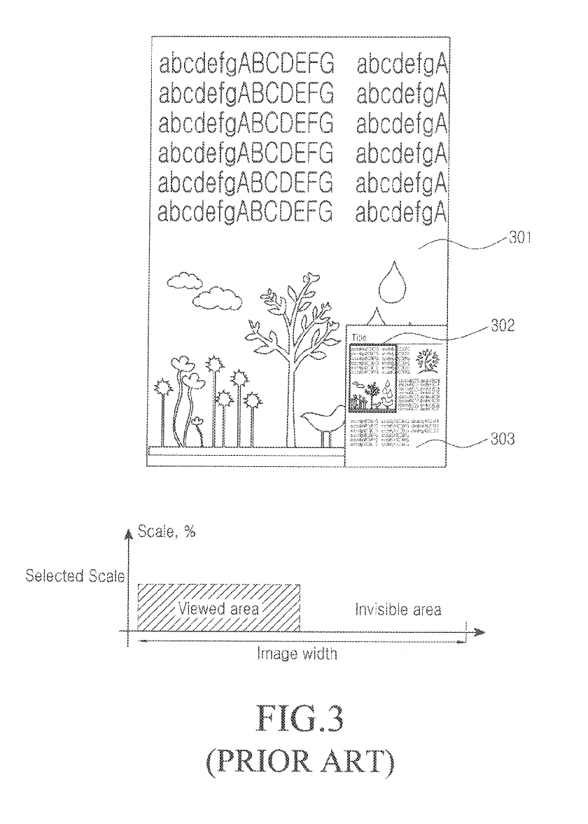

FIG. 4 illustrates a conventional method for displaying an image on a mobile device;

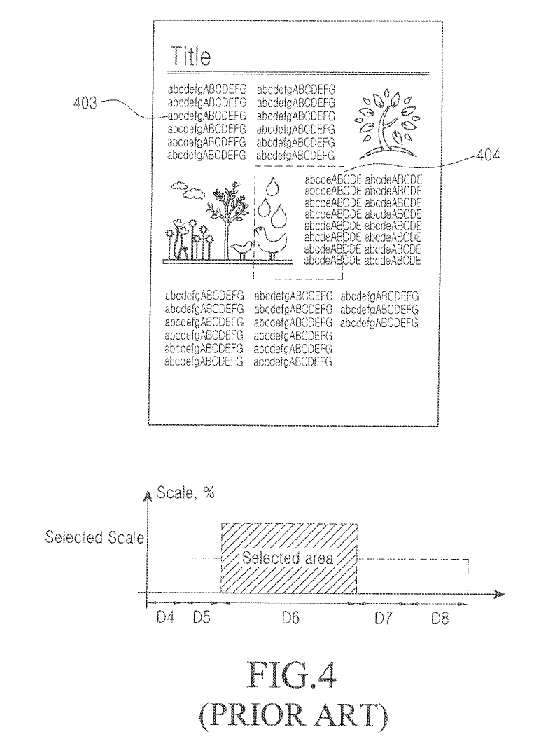

FIG. 5 illustrates a conventional method for displaying an image on a mobile device;

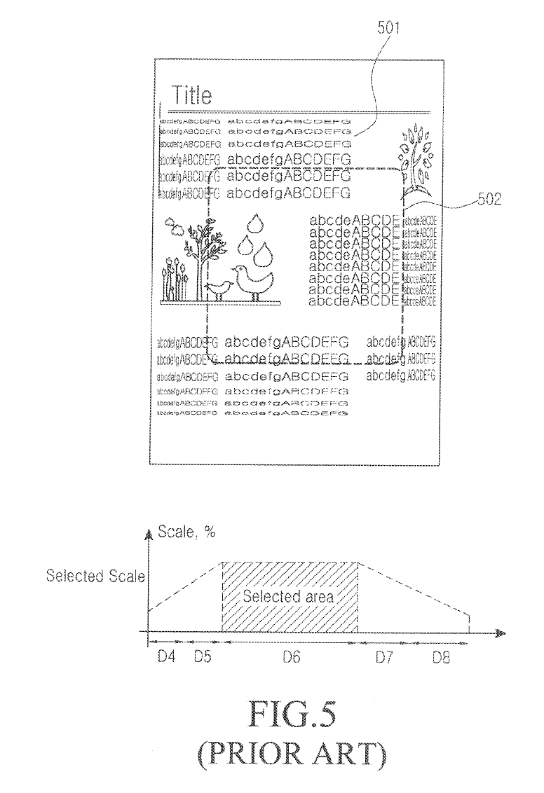

FIG. 6 is a flow chart illustrating an improved method of displaying an image that is larger than a display area of a display device, according to an embodiment of the present invention;

FIG. 7 is a block diagram illustrating an apparatus for displaying an image that is larger than a display area of a display device according to an embodiment of the present invention;

FIG. 8 illustrates a selected area on a touchscreen in a vertical orientation according to an embodiment of the present invention;

FIG. 9 illustrates a selected area on a touchscreen in a horizontal orientation according to an embodiment of the present invention;

FIG. 10 illustrates a method for moving of a selected area on a touchscreen according to an embodiment of the present invention;

FIG. 11 illustrates a method of increasing the scale of a selected area, according to an embodiment of the present invention; and

FIG. 12 illustrates a method of decreasing the scale of a selected area, according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

In accordance with an embodiment of the present invention, an improved method is provided for displaying an image that is larger than a display area of a display device. The method includes an image analysis stage, in which rows and columns of an initial image, which are part of background and foreground, are detected. The degree of deformation of the rows and columns of a background differs from the degree of deformation of rows and columns, which are part of foreground. That is, rows and columns of the background are deformed (e.g., compressed) more strongly in order to simultaneously display more helpful information on a screen and to use scaling, which is more comfortable for viewing, due to a more compact allocation of foreground objects.

Unlike conventional methods described above, a method in accordance with an embodiment of the present invention allows several areas of an initial image to be displayed in a chosen scale, which is comfortable for viewing and is more convenient for viewing images of documents with several columns of the text and tables, for example.

Additionally, in accordance with an embodiment of the present invention, any deformation/distortion may be used for non-selected image areas, which can create interesting visual effects when navigating over the image.

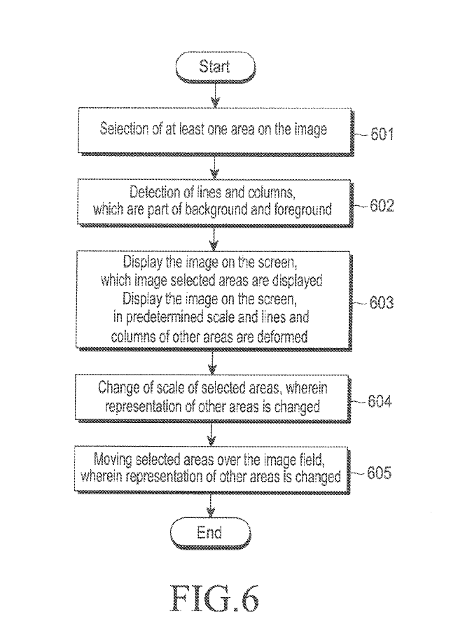

FIG. 6 is a flow chart illustrating an improved method of displaying an image that is larger than a display area of a display device, according to an embodiment of the present invention.

Referring to FIG. 6, in step 601, at least one area on an initial image is selected for viewing. In step 602, image analysis is performed to detect rows and columns of the image, which are part of background and foreground.

More specifically, a low-cut filter is applied along rows and columns for a brightness component of the image. A number of pixels of the filtered image is computed for each line and column. If the number of pixels in a line/column is less than a predetermined value, the line/column is identified as a part of the background. However, if the number of pixels in a line/column is greater than or equal to a predetermined value, the given line/column is identified as a part of the foreground.

In step 603, the image is displayed on a display device, wherein the selected areas are displayed in the predetermined scale, and rows and columns of other areas of the image are deformed according to the following rules:

(1) all areas of the image are simultaneously displayed on a display device;

(2) the degree of deformation of the rows and columns that are part of the background, differs from the degree of deformation of rows and columns which are part of foreground; and

(3) the degree of deformation of the rows and columns that are part of foreground vary in a process of moving away from the selected areas. For example, the degree of deformation can be determined to be displayed in a smaller size relatively, as a separate distance between rows and columns included in the foreground, and a selected area moves away.

Deformations/distortion of the non-selected areas can be performed in various ways. For example, deformation may include scaling rows and columns to decrease their size by using a variable coefficient of decrease. Dependence of change of coefficient of decrease can be set in a variety of ways, for example, linear, parabolic, piecewise, constant, etc.

In step 604, the scale of the selected areas is changed, wherein representation of the non-selected areas of the image is changed according to the rules described above.

There are a number of non-restricting variants of the sequence for changing the scale of each of the areas. For example, the scale of the selected areas may be changed jointly and equally for all such areas, or each selected area may changed independently.

In step 605, the selected areas are moved across the field of the image, wherein representation of other areas of the image is changed according to the rules claimed above. The selected area may be input within the field of the image in response to the user's input, and the corresponding area can be displayed on the display device by the method as described above.

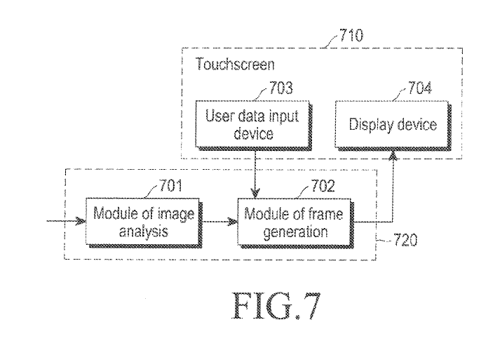

FIG. 7 is a block diagram illustrating an apparatus for displaying an image that is larger than a display area of a display device according to an embodiment of the present invention.

Referring to FIG. 7, the apparatus includes a touch screen 710 and a controller 720, e.g., a microprocessor. The touch screen 710 includes a user data input device 703 and a display device 704. Additionally, the controller 720 includes an image analysis module 701 and a frame generation module 702.

The image analysis module 701 detects rows and columns of the background and the foreground of the image, and outputs information about which of the rows and columns are part of background and which are part of foreground to the frame generation module 702. Herein, the foreground areas include informational areas of the image, such as symbols, figures, images, elements of vector graphics, etc. Further, the background areas include areas of an initial image that are part of the background and do not include graphic information.

The frame generation module 702 generates a frame so that selected areas of the image are displayed in a predetermined scale, and the rows and columns of other areas of the image, i.e., the non-selected areas, are deformed according to the above-described rules.

The coordinates and scale of the selected area or areas are transferred from the data input device 703 by the user. The prepared frame is formed and then displayed on the display device 704.

The user data input device 703 allows a user to select at least one area of the image and to change current coordinates and a scale of the selected areas.

Each of the modules 701 and 702 may be formed as Systems on a Chip (SoC), Field Programmable Gate Arrays (FPGAs), in the form of Application Specific Integrated Circuits (ASICs).

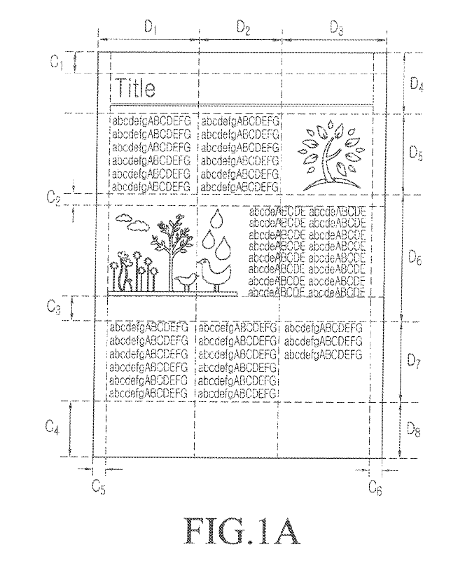

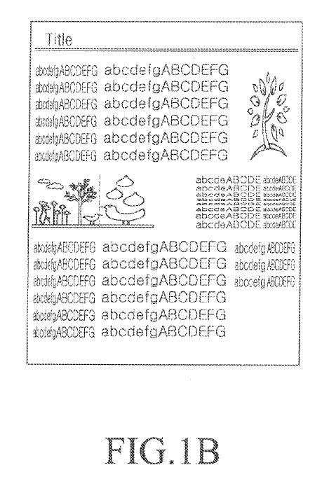

FIG. 1A illustrates an example of an initial image that is larger than a display area of a mobile device, and FIG. 1B illustrates the initial image as displayed on a mobile device according to an embodiment of the present invention.

Referring to FIG. 1B, two areas 101 and 102 are selected on a frame for viewing. A comfortable scale for viewing is set for the selected areas. The non-selected areas of the image (for example, area 103) are deformed according to the claimed method, according to an illustration, scale of these areas varies and scale so much the less, than further these areas are located from the selected areas.

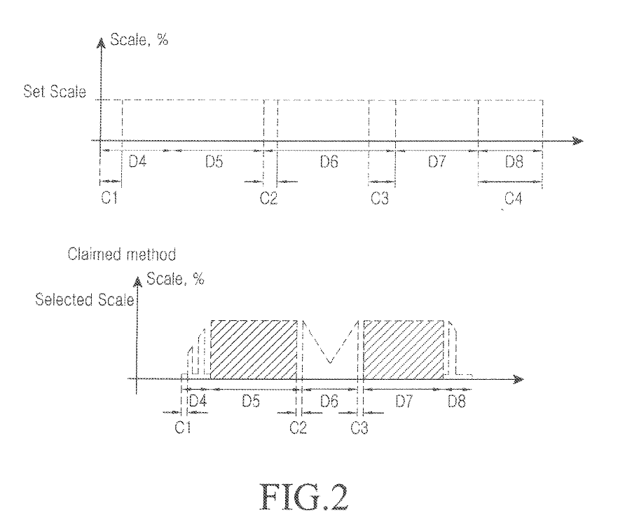

FIG. 2 illustrates the differences of scale between the initial image as illustrated in FIG. 1A and the displayed image illustrated in FIG. 1B according to an embodiment of the present invention.

Referring to FIG. 2, areas in bands of the image designated as C1, C2, C3, and C4 include rows that are part of the background. These areas are decreased more than the foreground areas. This allows non-uniform scaling of the non-selected areas that are out of the selected viewpoints, depending on their significance for the user. The scale in the chosen areas on intersection of band D2 with bands D5 and D7, i.e., the selected areas, is constant. The coefficient of decrease for other areas in bands D4, D6, and D8, i.e., the non-selected areas, becomes greater based on the distance moving away from the selected areas.

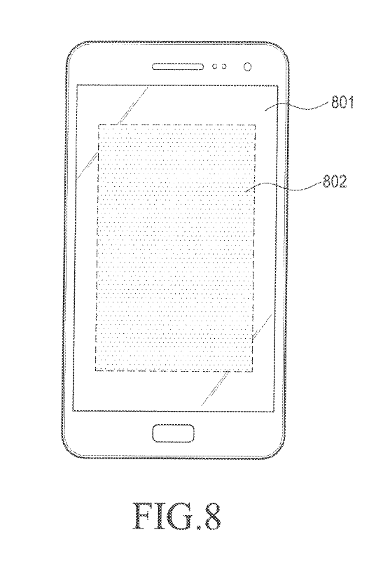

FIG. 8 illustrates a selected area on a touchscreen in a vertical orientation according to an embodiment of the present invention.

Referring to FIG. 8, an image is displayed on a screen 801. The viewing area 802 is selected. For example, the viewing area 802 may be selected by the user or may be automatically selected, according to settings based on a size of the screen.

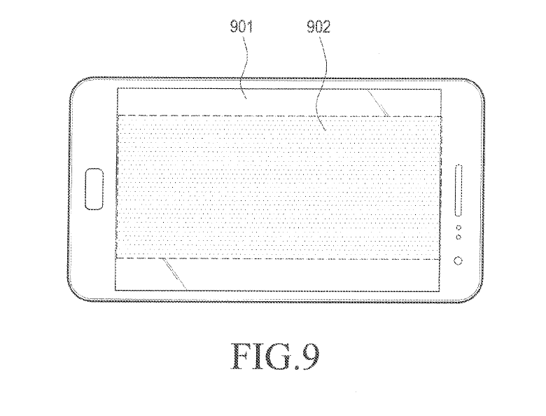

FIG. 9 illustrates a selected area on a touchscreen in a horizontal orientation according to an embodiment of the present invention.

Referring to FIG. 9, the size of the selected area 902 and its position can vary, depending on the orientation of the device screen 901.

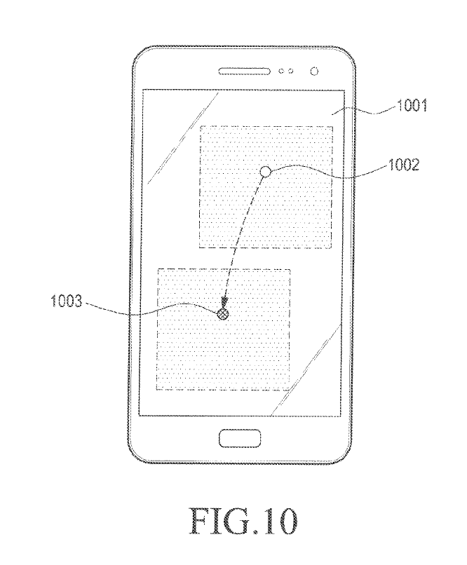

FIG. 10 illustrates a method for moving of a selected area on a touchscreen according to an embodiment of the present invention.

Referring to FIG. 10, a selected viewpoint may be moved according to a user input, e.g., due to a user input dragging on the screen in a new position. During the dragging, the user touches the screen at point 1002, which is inside the current selected area 1001 and, without stopping removing the touch, moves the touch point to new position 1003. Thereafter, the user removes the touch from the screen.

When moving the viewpoint, the frame generation module 702, as illustrated in FIG. 7, forms the frames that are representing the change of all areas on the image. A high frequency of generation of frames (e.g., several tens of frames per second), animates the moving and makes the interface attractive to the user.

Similarly, a size of the selected area may be changed by moving of an edge of the selected area. For example, the user touches the screen around edge of the selected area and in response to this touch, the selected area can be marked by any method suitable, for example, hashed lines, visualization of limiting rectangle, change of a transparency of the selected area, etc. Further, the user may change the size of the selected area, where a change of in a size of the area is proportional to the movement of a touch input.

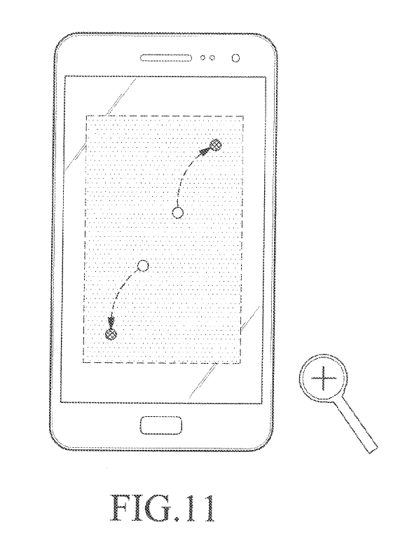

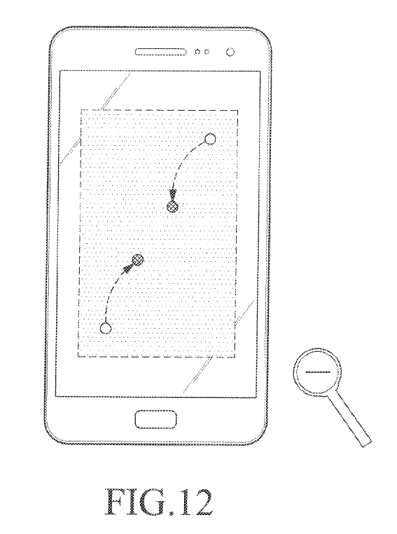

FIG. 11 illustrates a method of increasing the scale of a selected area, according to an embodiment of the present invention, and FIG. 12 illustrates a method of decreasing the scale of a selected area, according to an embodiment of the present invention.

Referring to FIGS. 11 and 12, the scale of the viewed image in the selected area is changed according to user inputs. For example, as illustrated in FIG. 11, the scale of the selected area can be increased using a pinch-out movement, wherein the user simultaneously touches two points inside selected area and, without stopping the touches, moves the points farther from each other.

Further, as illustrated in FIG. 12, the scale of the selected area can be decreased using a pinch-in movement, wherein the user simultaneously touches two points inside selected area and, without stopping the touches, moves the points closer to each other.

Besides changing the scale of the selected area using a pinch type touch, for example, a double touch with a small time interval therebetween at a point inside the selected area can correspond to an increase of scale of one predefined step, e.g., 10%. Similarly, a single touch of two points, located close to each other, can correspond to a decrease of scale by a step.

Additionally, other input commands can be used to change the size or scale of the selected areas.

Further, creation of an additional selected area is possible using a specified action, e.g., using double touch with a small time interval in between at a point outside of a current selected area on the screen. In reply to the specified action, the new selected area is created, e.g., centered on a position of the double touch input. Sizes of this area match to the predetermined values, but the area should not go outside the screen or intersect with already presented selected areas.

As another example, removal of a selected area can be performed by moving the selected area outside of the screen, or double touching a point in the selected area.

In accordance with the above-described embodiments of the present invention, an apparatus and method are provided for viewing images on devices having a screen with a display area that is smaller than the images. For example, the above-described embodiments of the present invention can be successfully applied in mobile phones, smart phones, electronic notepads, tablet PCs, electronic books, digital photoframes, displays of personal computers, TVs, etc.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for viewing an image on a display device, the image being larger than a display area of the display device, the method comprising:
selecting an area of the image;
detecting background and foreground areas in non-selected areas of the image; and
displaying the image on the display device,
wherein the selected area of the image is displayed in a predetermined scale, all of the background and foreground areas in the non-selected areas of the image are simultaneously displayed on the display device, a degree of deformation of the background areas, differs from a degree of deformation of the foreground areas, and the degree of deformation of the foreground areas changes in relation to distance moving away from the selected area.

2. The method of claim 1, further comprising changing the scale of the selected area, in response to a user input.

3. The method of claim 2, further comprising selecting another area of the image,
wherein the scales of the selected area and the another selected area are changed jointly and equally.

4. The method of claim 2, further comprising selecting another area of the image,
wherein the scale of the selected areas is changed independently for each selected area.

5. The method of claim 1, further comprising moving the selected area across the display area of the display device, in response to a user input.

6. The method of claim 1, wherein detecting the background and foreground areas in the non-selected areas of the image comprises:
performing low-cut filtering of a brightness component of areas in the non-selected area of the image;
computing a number of pixels of the filtered image for each of the areas in the non-selected area of the image;
comparing the number of pixels to a predetermined value;
determining that an area among the areas in the non-selected area of the image is a background area, if a corresponding number of pixels is less than the predetermined value; and
determining that an area among the areas in the non-selected area of the image is a foreground area, if a corresponding number of pixels is greater than or equal to the predetermined value.

7. The method of claim 1, wherein the degree of deformation decreases dimensions of an area using a variable coefficient of decrease.

8. An apparatus for viewing an image on a display device, the image being larger than a display area of the display device, the apparatus comprising:
a touchscreen display including the display area of the display device configured to display the image, and to receive a user input for selecting an area of the image; and
a controller configured to detect background and foreground areas in non-selected areas of the image, to control the touchscreen display to display the image on the display device,
wherein the selected area of the image is displayed in a predetermined scale, all of the background and foreground areas in the non-selected areas of the image are simultaneously displayed on the display device, a degree of deformation of the background areas, differs from a degree of deformation of the foreground areas, and the degree of deformation of the foreground areas changes in relation to distance moving away from the selected area.

9. The apparatus of claim 8, wherein the controller is configured to change the scale of the selected area, in response to a user input for changing the scale of the selected area.

10. The apparatus of claim 9, wherein the touchscreen display is configured to receiving a user input for selecting another area of the image, and
wherein the controller is configured to scale of the selected area and the another selected area are changed jointly and equally.

11. The apparatus of claim 9, wherein the touchscreen display is configured to receiving a user input for selecting another area of the image, and
wherein the controller is configured to change the scales of the selected areas independently.

12. The apparatus of claim 8, wherein the touchscreen display comprises:
a user data input device; and
a display device.

13. The apparatus of claim 8, wherein the controller is configured to move the selected area across the display area of the display device, in response to a user input.

14. The apparatus of claim 8, wherein the controller detects the background and foreground areas in the non-selected areas of the image by performing low-cut filtering of a brightness component of areas in the non-selected area of the image, computing a number of pixels of the filtered image for each of the areas in the non-selected area of the image, comparing the number of pixels to a predetermined value, determining that an area among the areas in the non-selected area of the image is a background area, if a corresponding number of pixels is less than the predetermined value, and determining that an area among the areas in the non-selected area of the image is a foreground area, if a corresponding number of pixels is greater than or equal to the predetermined value.

15. The apparatus of claim 8, wherein the degree of deformation decreases dimensions of an area using a variable coefficient of decrease.
